(19) United States
(12) Patent Application Publication
(10) Pub. No.: US 2017/0282853 A1
(43) Pub. Date: Oct. 5, 2017

(54) Device For Restraining A Passenger In A Holder Of An Amusement Ride

(71) Applicant: Mack Rides GmbH & Co. KG, Waldkirch (DE)

(72) Inventors: Günter Burger, Waldkirch (DE); Frank Sornik, Waldkirch (DE); Roman Hauer, Waldkirch (DE); Dennis Gordt, Emmendingen (DE)

(73) Assignee: Mack Rides GmbH & Co. KG, Waldkirch (DE)

(21) Appl. No.: 15/513,836

(22) PCT Filed: Sep. 17, 2015
(86) PCT No.: PCT/EP2015/071306

§ 371 Date: Mar. 23, 2017

(30) Foreign Application Priority Data
Sep. 24, 2014 (DE) 10 2014 113 869.4

(51) Int. Cl. B60R 22/48; A63G 31/00

(52) U.S. Cl. CPC B60R 22/48; A63G 31/00; B60R 2022/4808

(57) ABSTRACT

A mechanism for restraining a passenger restrained in a restraint system of an amusement ride, comprising at least one sensor device which includes a sensor for verifying whether there is a form-fit between the passenger and the mechanism.

The present invention relates to a device for restraining a passenger held in a holder of an amusement ride according to the preamble of patent claim 1, and a method for restraining a passenger held in a holder of an amusement ride according to the preamble of patent claim 12.

Restraint systems at amusement rides are, for example known from EP 1020212 B1, disclosing a restraint system for amusement vehicles, by which passengers are held at the lower part of their body. In general, passengers prefer this type of holder because, in contrast to constrictive over-the shoulder restraints, it enables a maximum ease of movement and, thus, an intense ride experience.

The secure holding of the passengers at the thighs is a function of different ergonomic measures, for example, resting the thighs by their entire surface in a fixed holder and/or at a movable holder of a passenger reception. Here and in the following, fixed holder is understood as a holder which is stationary in relation to the passenger reception and which serves to accommodate a body and/or a body region of the passenger, for example, a seat shell, a back shell, a front shell, a reclined shell seat, etc. A movable holder is understood as a holder which is movable in relation to the passenger reception and which serves to fixate or restrain the body and/or body region of the passenger in the fixed restraint, for example, a lap bar, a shoulder bar, an abdominal bar, a back bar, a leg bar, etc. On the basis of the different body dimensions of the passengers, it results that a wide range of people has to be taken into account when ergonomically configuring the restraint system. This also requires, for example, an individually adjustable position of the movable restraint for the form-locking inclusion of the passenger in the restraint system.

For conventional restraint systems as described, for example, in EP 1020212 B1, the passenger him/herself assumes the correct sitting position and the body proximal fitting of the movable restraint, the service personnel of the amusement ride verifying the correct sitting position and the body proximal fitting. For different reasons, for example misbehavior, wearing bulky clothing or carried objects, the correct sitting position and the body proximal fitting of the movable holder may be restricted.

Restraint systems in which a maximum position of the movable holder, which relates to the most corpulent person still allowed to join the ride, is detected with the aid of sensors, are, however, also conceivable. This type of restraint system is however insufficient because, inherent to the system, clearance to start would be given to a child as soon as the movable holder is located just below the maximum position. In this case, the space between the thigh of the child and the movable holder would be so great that the child could easily deboard, which for security reasons is of course not allowed to take place.

Sensor devices at holders for passengers are known from the automotive industry. For example, DE 199 83 956 B4 discloses an occupant sensor detecting the presence of an occupant on a seat bottom component for controlling an airbag restraint system.

A restraint bar for securing a person in vehicles, in particular for rail-bound amusement park rides, is known from DE 100 16 213 C1. The sensor of DE 100 16 213 C1, however, does not detect objects carried between an over-the-shoulder restraint and the passenger and, for this reason, does not ensure a form, lock between restraint bar and passenger.

The object of the present invention is to provide a restraint system which ensures a necessary form lock in an amusement ride between restraint system and passenger and, thus, increases the safety of restraint systems in amusement rides. Form lock is here and subsequently understood as the fitting or resting of the movable holder at the passenger.

The object of the present invention is achieved by a device having the features of patent claim 1 and by a method having the features of patent claim 12.

Advantageous embodiments and further refinements of the present invention are described in the dependent claims.

The device according to the present invention for restraining a passenger held in a holder of an amusement ride has at least one sensor device, which on its part has means by which a form lock between a passenger and the device may be verified.

The sensor device according to the present invention verifies a form lock between the passenger and the holder of an amusement ride, for example a roller coaster in amusement parks, the setting of the form lock not being limited to the upper body of the passenger and the holder, as it is customary in the automotive industry, but, for example, also ensuring a form lock between the thighs of the passenger and the holder.

To sensorially verify the form lock between the passenger and the holder of an amusement ride increases the safety for operating amusement rides and ensures a clearance to start the amusement ride exclusively when the holder fits correctly and in a body proximate manner. The device according to the present invention supports the service personnel of the amusement ride in detecting, for example, a faulty sitting position and/or a non-proximal fitting of the body at the movable holder by objects impairing the form lock.

The device for restraining a passenger in an amusement ride is preferably configured in such a manner that the means of the sensor device are able to detect bodies and/or the body positions of passengers.

The detection of bodies and/or body positions of passengers ensures that a clearance to start the amusement ride occurs only when the passenger is correctly positioned in his/her seat. Different body dimensions of the passengers may thus easily be detected. Furthermore, it may be detected in this way whether a passenger for a more intense ride experience would like to achieve greater leeway in the back or buttocks area by over-stretching the body -when boarding, as a result of which the form lock between the passenger and the holder no longer would be ensured without a sensorial detection of the body and/or body positions. In this case, the device however detects that a form lock is no longer ensured and a clearance to start is not initiated.

According to a further refinement of the present invention, the means of the sensor device are configured for a comparison measurement of individual body parts and/or body regions of passengers to a specified holder position.

Such a comparison measurement of individual body parts and/or body regions to a specified holder position has the advantage that even foreign objects, such as prostheses, may be recognized.

It is particularly advantageous if the sensor device has an optical scanner which carries out comparison measurements of individual body parts and/or body regions of passengers to a predetermined holder position. In this instance, the scanner is able to visually detect the passenger and compare the image detected in this way to the predetermined holder position.

Advantageously, the sensor device has a temperature sensor and/or a surface sensor and/or a pressure sensor and/or a sensor detecting a displaceable or compressible medium and/or an ultrasonic sensor and/or an infrared sensor.

For example, temperature sensors detecting the body temperature of passengers recognize carried objects or bulky clothing. If such objects are located between body and temperature sensor, a preset minimum temperature would not be reached and the clearance to start would be negative.

According to a preferred embodiment of the present invention, a movable holder is provided, and the means of the sensor device being configured for monitoring the body proximal fitting of the movable holder at the body of the passenger.

Misbehavior of the passenger, for example, over-stretching the body in the back and/or buttocks area when boarding, may be easily recognized by sensorially monitoring the body proximal fitting of the movable holder. For this reason, the sensorial monitoring of the body proximal fitting of the movable holder is particularly well suited to support the service personnel of the amusement ride and, thus, assists in reducing human error and in increasing the safety for the passengers.

Advantageously, the device is configured to issue a clearance to start for the amusement ride.

In this instance, the clearance to start occurs only after a positive feedback signal of the means of the sensor device. Thus, it becomes more certain that the required form lock between restraint system and passenger is ensured.

The holder of the device according to the present invention has in particular a seat shell, a movable holder and a back shell.

A holder having a seat shell, a movable holder and a back shell provides particularly good ergonomics in the holder of amusement rides.

Advantageously, the sensor device is mounted in the holder of the seat shell, the movable holder or the back shell. Sensors mounted in the seat shell and the back shell ensure a correct detection of the sitting position of the passenger in the holder of an amusement ride. Sensors in the movable holder monitor the body proximal fitting of the movable holder.

To detect as much information about the dimensions of the body of the passenger as possible, the device preferably has a plurality of sensor devices, the sensor devices in the holder being mounted in the movable holder or in the movable holder and the seat shell and/or in the back shell.

In so doing, for example, one sensor device may have temperature sensors and another sensor device may have pressure sensors so that, beside the body temperature and/or the temperature-dependent distance measurement of passengers, contact forces of passengers in the holder of the amusement ride may be additionally detected. Retrieving the body temperature and/or the distance on the basis of the temperature measurement and the contact, forces of passengers contributes to a better detection of the body or body parts of the passengers and to the differentiation to objects.

In a further refinement of the present invention, the sensor device is mounted partially or completely outside of the holder of the amusement ride. A sensor device mounted outside of the holder of the amusement ride could, for example, be mounted inside of the station of the amusement ride and detect the form lock between the passenger and the holder of the amusement ride also while the amusement ride is traveling through the station.

The restraining of a passenger held in a holder of an amusement ride is adjusted according to the present invention in that a measuring unit as an input signal detects the dimensions of the passenger detected by the means of the sensor device. The measuring unit transmits the input signals to an adjusting device. The adjusting device adjusts the holder to the dimensions of the passenger before starting the amusement ride.

Such a method supports the service personnel of the amusement ride in the detection of misbehavior, for example, a faulty sitting position, bulky clothing or objects impairing the form lock. The clearance to start the amusement ride, which in known restraint systems has so far been able to occur within the area of the closing position of the movable holder even for an incorrect closing position of the movable holder, is now only possible if the movable holder indeed fits in a body proximal manner.

In a further refinement of the present invention, the dimensions of the passenger are detected when the amusement ride travels through the area for take-off of the amusement ride.

This further refinement of the method according to the present invention enables to detect the correct form lock between restraint system and passengers also while operating the amusement ride.

Preferably, the adjusting device of the method according to the present invention has an actuator. An actuator may, for example, particularly easily adjust the movable holder.

The present invention is described in greater detail on the basis of the exemplary embodiments of the subsequent figures.

FIG. 1 shows a front view of an exemplary embodiment of a device for restraining a passenger held in a holder of an amusement ride;

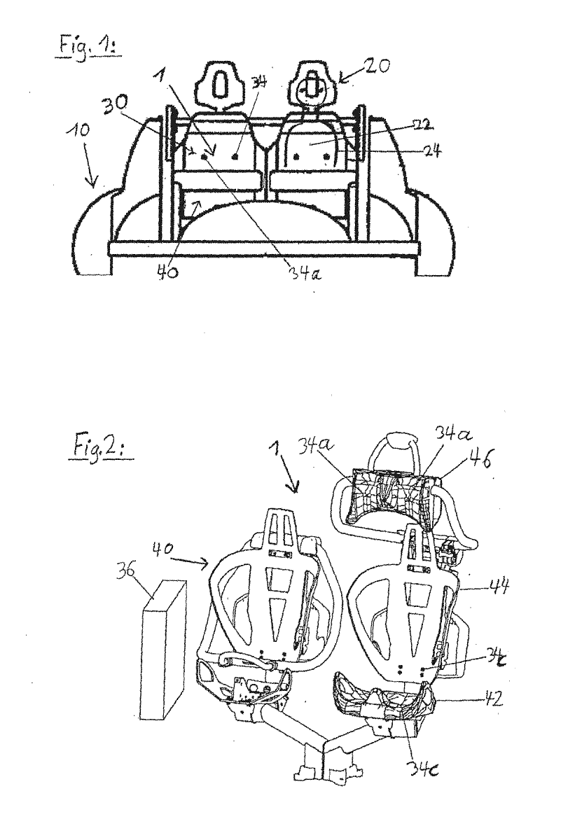

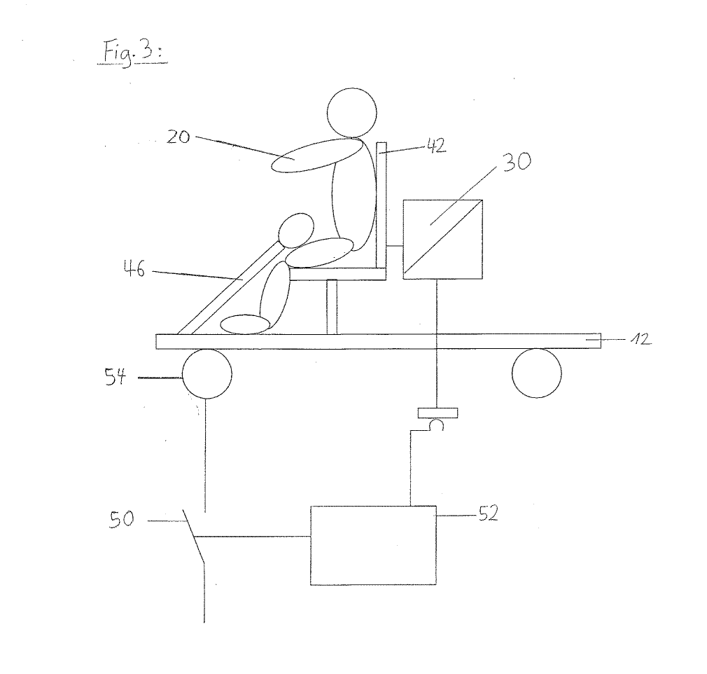

FIG. 2 snows a detailed view of a holder having a device for restraining a passenger according to FIG. 1;

FIG. 3 shows a block diagram for illustrating the method according to the present invention according to FIG. 1.

FIG. 1 shows a front view of an exemplary embodiment of a device 1 for restraining a passenger 20 held in a holder 40 of an amusement ride 10.

FIG. 2 shows a detailed view of a holder 40 having a device 1 according to FIG. 1.

FIG. 3 schematically shows the method according to the present invention for adjusting the device according to FIG. 1 on the basis of a block diagram.

To avoid unnecessary repetitions, FIGS. 1 through 3 are subsequently jointly addressed.

The exemplary embodiment shows an amusement ride 10 having a device 1 for restraining a passenger 20. Passenger 20 is held in a holder 40, holder 40 being accommodated in a passenger reception 12, for example, in a vehicle, in a cable car, in a cab. The amusement ride may, for example, be a rail-mounted amusement ride in an amusement park, in particular a roller coaster.

Modern restraint systems at amusement rides 10 are conceptualized in such a manner that they secure passenger 20 by having the least possible points of contact with the passenger. Holder 40 of the exemplary embodiment in FIG. 1 holds passenger 20, for example, at his/her not-shown thighs.

Device 1 has a sensor device 30 provided by means 34, by which a form lock between passenger 20 and device 1 may be monitored. In the exemplary embodiment here shown, sensor unit 30 has a temperature sensor 34a which detects the body temperature of passengers 20. Sensor device 30, however, is not limited to only temperature sensor 34a. Surface sensors 34b here not shown, pressure sensors 34c, sensors 34d detecting a displaceable or compressible medium or capacitive sensors 34e or ultrasonic sensors 34f or infrared sensors 34g or other sensors may also be used for detecting the dimensions of a passenger 20.

These means 34 of sensor device 30 may detect body 22 and/or body positions 24, for example, a seated body position 24 of passenger 20, as shown in the exemplary embodiment of FIG. 1, or body regions 26 of passengers 20.

On the basis of the different body dimensions of passengers 20, it results that a wide range of people has to be taken into account when ergonomically conceptualizing holder 40. This, for example, also requires the individually adjustable position of movable holder 46, into which means 34 of sensor device 30 may be mounted. Means 34 of sensor device 30 mounted in movable holder 46 monitor the form lock between passenger 20 and movable holder 46 or holder 40. Body 22 of passenger 20 is wedged in holder 40 in such a way that passenger 20 is enclosed in a form-locking manner in holder 40. Thus, the passenger is not able to escape holder 40, neither by arising acceleration forces nor by his/her own doing.

The exemplary embodiment shows a scanner 36 which is situated separate from holder 40. Scanner 36 carries out a comparison measurement of individual body parts and/or body regions of passengers 20 to a predetermined holder position. Expediently, scanner 36 detects for the comparison measurement an optical image of passenger 20, which then may be easily compared to a predetermined holder position. Foreign objects of passengers 20, for example, backpacks, bags, etc., may be easily and reliably detected by such an optical comparison measurement.

Shown holder 40 has a seat shell 42, a back shell 44 and a movable holder 46, The sensor device in the exemplary embodiment of FIG. 2 includes temperature sensors 34a situated in movable holder 46, as well as pressure sensors 34c situated in back shell 44 and in seat shell 42. Holders 40 having other sensors are of course also conceivable. The use of sensors quantitatively detecting different measured variables, such as, for example, temperature sensors 34a, which detect the body temperature of passengers 20, and pressure sensors 34c, which detect the contact forces of passengers 20 in back shell 44 and seat shell 42, in the exemplary embodiment, ensure a secure detection of body 22 and body positions 24 of a passenger 20.

Means 34 of sensor device 30 may be mounted in holder 40 or outside of amusement ride 10, for example in the take-off area, and monitor the form lock between passenger 20 and holder 40 while amusement ride 10 travels through the take-off area or before the departure of amusement ride 10.

In the shown method for restraining a passenger 20 held in a holder 40 of an amusement ride 10 by a device 1 an adjusting device 50 is used. As an input signal, a measuring unit 52 receives the dimensions of passenger 20 detected by means 34 of sensor device 30. Measuring unit 52 transmits the input signals to adjusting device 50. Adjusting device 50 is able to adjust holder 40 of the amusement ride before take-off and/or while amusement ride 10 is traveling through the take-off area. In the simplest case, the adjusting device has an actuator 54, which adjusts the body proximal fitting of movable holder 46 at body 22 of passenger 20.

The sensorial monitoring of body position 24 and of the body proximal fitting of movable holder 46 by sensor device 30 increases the safety so that the form lock between passenger 20 and holder 40 is ensured.

Device 1 for restraining passengers 20 supports the service personnel of amusement rides 10 in the detection of misbehavior, for example, faulty sitting positions, bulky clothing or objects impairing the form lock. The clearance to start amusement ride 10, which so far has been able to occur within the area of the closing position of movable holder 46 even for an incorrect closing position of movable holder 46, is now only possible if movable holder 46 indeed fits in a body proximal manner at body 22 of passenger 20.

As a support system, for supporting the service personnel, device 1 shown in the exemplary embodiment assists to reduce human error and, thus, to increase the safety for passengers 20.

### LIST OF REFERENCE CHARACTERS

1 device for restraining

10 amusement ride

12 passenger reception

20 passenger

22 body

24 body position

26 body region

30 sensor device

34 means

34a temperature sensor

34b surface sensor

34c pressure sensor

34d sensor detecting a displaceable or compressible medium

34e capacitive sensor

34f ultrasonic sensor

34g infrared sensor

36 scanner

40 holder

42 fixed holder

46 movable holder

50 adjusting device

52 measuring unit

54 actuator

1. A device for restraining a passenger held in a holder of an amusement ride comprising:
a sensor device,
wherein the sensor device has a sensor for detecting and monitoring a specific sitting position of the passenger in an amusement ride seat.

2. The device according to claim 1, wherein
the sensor of the sensor device detects a passenger body, a passenger body region, a passenger body position, or a combination thereof.

3. The device according to claim 1, wherein
the sensor of the sensor device compares a measurement of a passenger body, a passenger body region, or a combination thereof, to a predetermined body position.

4. The device according to claim 1, further comprising a scanner.

5. The device according to claim 1, wherein
the sensor of the sensor device comprises a temperature sensor, a surface sensor, a pressure sensor, a displaceable or compressible medium sensor, a capacitive sensor, an ultrasonic sensor, an infrared sensor, or a combination thereof.

6. The device according to claim 1, wherein
the sensor of the sensor device detects and monitors a proximal fitting of a movable holder at the passenger body.

7. The device according to claim 1, wherein
the sensor of the sensor device detects and monitors a passenger body position in relation to a fixed holder.

8. The device according to claim 1, wherein
the device for restraining a passenger is configured to issue a clearance to start for the amusement ride.

9. The device according to claim 1, further comprising:
a holder, including a fixed holder and a movable holder.

10. The device according to claim 9, wherein
the sensor of the sensor device is mounted in the fixed holder, the movable holder, or both the fixed holder and the movable holder.

11. The device according to claim 1, wherein
the sensor device includes a plurality of sensor devices, wherein an individual sensor device of the plurality of sensor devices is mounted in a movable holder, in a seat shell, or in a back shell.

12. The device according to claim 1, wherein
the sensor device is mounted at least partially outside of the holder of the amusement ride.

13. A method for restraining a passenger of an amusement ride comprising:
providing a device for restraining a passenger held in a holder of an amusement ride having
a sensor device, wherein the sensor device has a sensor for detecting and monitoring a specific sitting position of the passenger in an amusement ride seat; and
a measuring unit;
an adjusting device;
detecting passenger dimensions with the measuring unit by using at least one of the sensor device devices;
transmitting the passenger dimensions to the adjusting device; and
adjusting, via the adjusting device, the holder to the passenger dimensions before the amusement ride starts.

14. The method according to claim 13, further comprising:
detecting the passenger dimensions when the amusement ride travels through an area for take-off of the amusement ride.

15. The method according to claim 13, further comprising:
enabling take-off for the amusement ride after adjusting the holder to the passenger dimensions.

16. The device according to claim 1, further comprising an adjusting device with an actuator.
